(19) United States
(12) Patent Application Publication
(10) Pub. No.: US 2024/0406755 A1
(43) Pub. Date: Dec. 5, 2024

(54) TRAFFIC SIGNATURE-BASED NETWORK SLICE POLICY ACTIONS

(71) Applicant: Verizon Patent and Licensing Inc., Basking Ridge, NJ (US)

(72) Inventors: Ravi Potluri, Coppell, TX (US); Kalyani Bogineni, Irving, TX (US); Sudhakar Reddy Patil, Flower Mound, TX (US); Jude M. Munn, Pittsburg, CA (US)

(21) Appl. No.: 18/325,460

(22) Filed: May 30, 2023

(51) Int. Cl. H04W 24/02; H04W 24/08; H04W 28/02

(52) U.S. Cl. CPC H04W 24/02; H04W 24/08; H04W 28/0226

(57) ABSTRACT

A network device monitors traffic associated with a network slice in a mobile network and applies machine learning to the monitored first traffic to determine at least one metric for detecting traffic anomalies in the network slice. The network device triggers, based on the determined at least one metric, at least one of: applying policy rules to second traffic in the network slice, or updating the policy rules for the network slice.

### BACKGROUND

Next Generation mobile networks, such as Fifth Generation New Radio (5G NR) mobile networks, may operate in various frequency ranges, including higher frequency ranges (e.g., in the gigahertz (GHz) frequency band), and may have a broad bandwidth (e.g., near 500-1,000 megahertz (MHz)). The bandwidth of Next Generation mobile networks supports higher speed downloads and uploads. The 5G mobile telecommunications standard supports more reliable, massive machine communications (e.g., machine-to-machine (M2M), Internet of Things (IoT)). Next Generation mobile networks, such as those implementing the 5G mobile telecommunications standard, are expected to enable a higher utilization capacity than current wireless networks, permitting a greater density of wireless users. Next Generation mobile networks are designed to increase data transfer rates, increase spectral efficiency, improve coverage, improve capacity, and reduce latency.

### BRIEF DESCRIPTION OF THE DRAWINGS

FIG. 1 depicts an example of a network environment in which traffic signature-based network slice policy actions may be implemented;

FIG. 2 depicts an example of the division of the mobile network into multiple (n) network slices;

FIG. 3 illustrates an example of the interoperation of the slice traffic manager, the slice orchestrator, and various network slice NFs for performing traffic signature-based network slice policy actions;

FIG. 4 illustrates exemplary components of the slice orchestrator related to slice management and orchestration;

FIG. 5 is a diagram that depicts exemplary components of a network device;

FIG. 6 is a flow diagram of an exemplary process for configuring traffic management functions for a network slice;

FIG. 7 is a flow diagram of an example process for monitoring traffic associated with a network slice, learning traffic patterns of traffic in the network slice, and generating and storing corresponding traffic signatures of traffic associated with the network slice;

FIG. 8 depicts operations associated with an example process;

FIG. 9 is a flow diagram of an example process for applying machine learning to monitored traffic of a network slice to detect traffic anomalies; and

FIG. 10 depicts operations associated with another example process.

### DETAILED DESCRIPTION OF EXAMPLE EMBODIMENTS

The following detailed description refers to the accompanying drawings. The same reference numbers in different drawings may identify the same or similar elements. The following detailed description does not limit the invention.

“Network Slicing” is an innovation for implementation in Next Generation Mobile Networks. Network slicing is a type of virtualized networking architecture that involves partitioning of a single physical network into multiple virtual networks that may be composed of various Virtual Network Functions (VNFs). VNFs include network functions that have been moved out of dedicated hardware devices into software that runs on commodity hardware. VNFs may be executed as one or more Virtual Machines (VMs) on top of the hardware networking infrastructure. Examples of various VNFs include switches, routers, servers, tunneling gateway elements, traffic analysis functions, mobile network nodes (e.g., User Plane Function (UPF), Session Management Function (SMF), Access and Mobility Management Function (AMF), Unified Data Management (UDM) function, Policy Control Function (PCF)), and security functions (e.g., firewalls, intrusion detection systems, virus scanners, and spam protection). The partitions, or “slices,” of a virtualized network, including each slice's VNFs, may be customized to meet the specific needs of applications, services, devices, customers, or operators. Each network slice can have its own architecture, provisioning management, and security that supports data sessions transported over the network slice. Bandwidth, capacity, and connectivity functions are allocated within each network slice to meet the requirements of the objective of the particular network slice. For example, each network slice, when created in a mobile network, may be designed to satisfy one or more performance characteristics or performance requirements for data sessions that are serviced by the network slice. Network slicing may be implemented in a dynamic fashion, such that the slices of the virtualized network may change over time and may be re-customized to meet new or changing needs of applications, services, devices, customers, or operators.

VNFs are components of an overall Network Functions Virtualization (NFV) architecture that may be employed within network slices. NFV is a part of an initiative, as networks move to a Software Defined Network (SDN) model, to virtualize network services traditionally run on proprietary, dedicated hardware. NFV virtualizes classes of VNFs into building blocks that may be connected, or chained together, to create network services. With NFV, VNFs are packaged as Virtual Machines (VMs) on commodity hardware, instead of traditional network services being executed by proprietary, dedicated hardware. A NFV architecture typically includes a NFV infrastructure (NFVI) and a network functions virtualization management and orchestration architectural framework (NFV-MANO). NFVI includes the hardware and software components that build the environment where VNFs are deployed. The NFVI can span several different locations, with connectivity between the locations. The NFV-MANO includes a collection of functional blocks, data repositories, and interfaces through which the functional blocks of the NFV-MANO exchange information to manage and orchestrate the NFVI and VNFs. Network slicing, through the use of NFV and SDNs, enables Next Generation mobile networks (e.g., Fifth Generation (5G) mobile networks) to offer a variety of services, which may be altered in a dynamic fashion, that demand different network performances for different types of sessions.

Network slicing is a key benefit of Next Generation wireless network architectures, such as the 5G network architecture. Next Generation mobile networks are expected to support network slices that satisfy one or more performance characteristics or performance requirements for data sessions that are serviced by the network slices. Particular network slices may be built to support a class of applications (e.g., gaming, office apps, media streaming, messaging) requiring particular capabilities, such as, for example, low latency and/or high uplink bandwidth. Current network slice management mechanisms implemented on user equipment devices (UEs) utilize UE Route Selection Policy (URSP) rules to guide the mapping of a specific application to a network slice. This mapping, however, depends on the UE's Operating System (OS) accurately interpreting the application's connectivity request and identifying the corresponding mapping. Given the variety of UEs (and differing OSs) that may use the network slices, additional network-side mechanisms for network slice traffic admission and management can assist in ensuring the balanced use of network slice resources. However, for network-side resource management techniques, some knowledge of traffic characteristics on the network slices is needed, and these traffic characteristics are typically not known apriori. Network-side slice traffic admission and management techniques also need to support policies and rules that will be dynamic and adaptable to the network conditions, and to the mix of UEs and the particular UE traffic currently using each network slice.

The traffic management techniques described herein enable the monitoring and detection of anomalous traffic on a network slice, and use of the detected anomalous traffic to trigger policy actions within the network slice. The traffic management techniques described herein adapt to changing traffic patterns and avoid the use of pre-defined rules to detect traffic anomalies. The policy actions may include triggering application of policy rules by the Policy Control Function (PCF) and/or triggering the updating of policies at the PCF. The techniques described herein use machine learning (ML) to monitor and collect traffic attributes on traffic associated with a network slice and identify traffic patterns based on the monitored traffic attributes. The identified traffic patterns may be stored as network slice-specific “traffic signatures.” The traffic attributes may include, for example, traffic volume characteristics (e.g., downlink (DL) volumes, uplink (UL) volumes, ratio of DL to UL volumes), types of traffic (e.g., DL protocol, UP protocol, app servers), and/or traffic temporal characteristics (e.g., inter-packet arrival gaps, session duration, burstiness of packets, packet size). A ML technique such as, for example, the Random Cut Forest (RCF) ML algorithm, may pattern match against the stored traffic signatures to detect anomalies and generate an anomaly score or scores for the network slice. Policy actions, via triggering of policies at the PCF and/or via updates to the PCF in the network slice, may be implemented based on a level of the generated anomaly score(s).

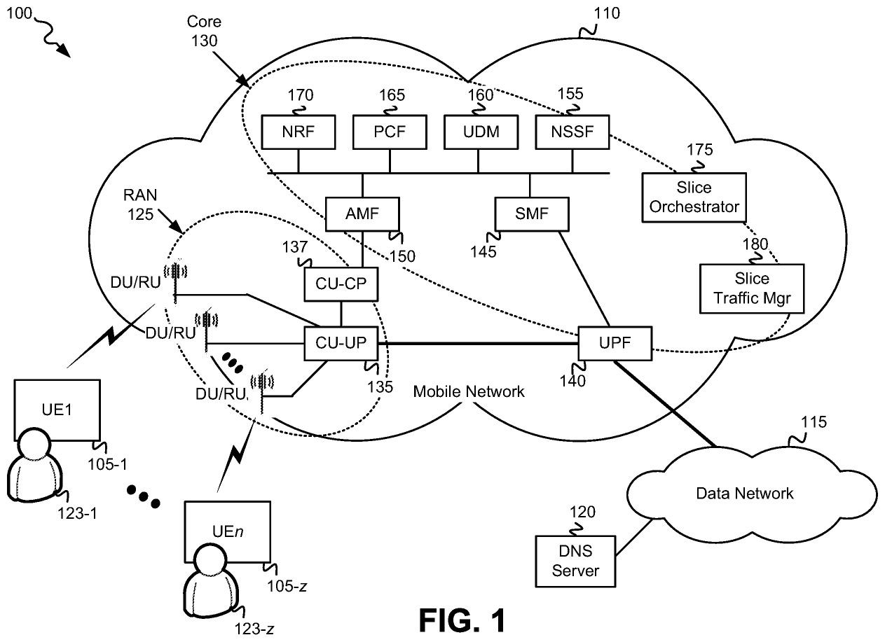

FIG. 1 depicts an example of a network environment 100 in which traffic signature-based network slice policy actions may be implemented, as described further herein. As shown, network environment 100 may include UEs 105-1 through 105-z (generically referred to herein as a “UE 105” or “UEs 105”), a mobile network 110, a data network(s) 115, and a Domain Name System (DNS) server 120.

UEs 105-1 through 105-z may each include any type of device having a communication capability, such as, for example, a wireless communication capability. UEs 105 may include, for example, a laptop, palmtop, wearable, or tablet computer; a cellular phone (e.g., a “smart” phone); a Voice over Internet Protocol (VOIP) phone; an audio speaker (e.g., a “smart” speaker); a video gaming device; a music player (e.g., a digital audio player); a digital camera; a device in a vehicle; a wireless telematics device; an Augmented Reality/Virtual Reality (AR/VR) headset or glasses; or an Internet of Things (IoT) or Machine-to-Machine (M2M) device. A user may carry, use, administer, and/or operate each UE 105. A user 123-1 is shown in association with UE 105-1 and a user 123-z is shown in association with UE 105-z.

Mobile network 110 may include a Public Land Mobile Network (PLMN) (referred to herein as a “mobile network 110” or a “network 110”) and possibly one or more other networks (not shown). Mobile network 110 may include other sub-networks, such as a Radio Access Network (RAN) 125 and a core network 130.

RAN 125 may include various types of radio access equipment that implement Radio Frequency (RF) communication with UEs 105. The radio access equipment of RAN 125 may include, for example, multiple Distributed Units (DUs) and Remote Units (RUs), and at least one Control Unit-User Plane function (CU-UP) 135 and at least one Control Unit-Control Plane (CU-CP) function 137. Only a single one of CU-UP 135 and CU-CP 137 is shown in FIG. 1, however, RAN 125 may include multiple CU-CPs and CU-UPs. Each DU includes a logical node that hosts functions associated with the Radio Link Control (RLC) layer, the Medium Access Control (MAC) layer, and the physical layer (PHY). A RU may be connected to each DU, and each RU may include at least one radio transceiver, and associated antenna(s), for RF wireless communication with one or more UEs 105 within radio range of the RU.

CU-UP 135 may interconnect with one or more DUs of RAN 125 via fronthaul links or a fronthaul network, and may include a logical node that hosts user plane functions, such as, for example, data routing and transport functions. CU-CP 137 includes a logical node that hosts Radio Resource Control (RRC), and other control plane, functions (e.g., Service Data Adaptation Protocol (SDAP), Packet Data Convergence Protocol (PDCP)) for the CU-UP 135. RAN 125 may additionally include other nodes, functions, and/or components not shown in FIG. 1.

Core network 130 includes devices or nodes that implement NFs that operate the mobile network 110 including, among other NFs, mobile network access management, session management, and policy control NFs. In the example network environment 100 of FIG. 1, core network 130 is shown as including a 5G mobile network that further includes 5G Network Functions (NFs), such as a UPF 140, a SMF 145, an AMF 150, a Network Slice Selection Function (NSSF) 155, a UDM function 160, a PCF 165, a Network Repository Function (NRF) 170, a slice orchestrator 175, and a slice traffic manager 180. UPF 140, SMF 145, AMF 150, NSSF 155, UDM 160, PCF 160, NRF 170, slice orchestrator 175, and slice traffic manager 180 may be implemented as VNFs within mobile network 110.

UPF 140 may act as a router and a gateway between mobile network 110 and data network 115, and forwards session data between data network 115 and RAN 125. Though only a single UPF 140 is shown in FIG. 1, mobile network 110 may include multiple UPFs 140 at various locations in network 110. SMF 145 performs session management, allocates network addresses to UEs 105, and selects and controls UPFs 140 for data transfer. AMF 150 performs authentication, authorization, and mobility management for UEs 105. NSSF 155 selects a set of network slice instances (NSIs) that may serve a UE 105, and determines the allowed single Network Slice Selection Assistance Information (S-NSSAI) for a UE 105. UDM 160 manages data for user access authorization, user registration, and data network profiles. UDM 160 may include, or operate in conjunction with, a User Data Repository (UDR—not shown) which stores user data, such as customer profile information, customer authentication information, and encryption keys. PCF 165 implements policy and charging control for service data flows and Protocol Data Unit (PDU) session related policy control.

NRF 170 operates as a centralized repository of information regarding NFs in mobile network 110. NRF 170 enables NFs (e.g., UPF 140, SMF 145, AMF 150, UDM 160) to register and discover each other via an Application Programming interface (API). NRF 170 maintains an updated repository of information about the NFs available in mobile network 110, along with information about the services provided by each of the NFs. NRF 170 further enables the NFs to obtain updated status information of other NFs in mobile network 110. NRF 170 may, for example, maintain profiles of available NF instances and their supported services, allow NF instances to discover other NF instances in mobile network 110, and allow NF instances to track the status of other NF instances.

Slice orchestrator 175 performs, among other operations and functions, network slice and NSI creation, virtual network resource allocation, instantiation, and provisioning, and network slice and NSI monitoring, reporting, and life cycle management (LCM).

Slice traffic manager 180 performs various functions, as described in further detail below, related to network slice traffic management, including, for example, monitoring network slice CU and UP traffic, learning traffic patterns for each network slice based on the traffic monitoring, and storing the learned patterns as traffic signatures. Slice traffic manager 180 further monitors the network slice CU and UP traffic to determine distance metrics from the stored traffic signatures and generates anomaly scores based on the distance metrics to detect traffic anomalies. Slice traffic manager 180 additionally triggers application of PCF policy rules, or triggers updating of policies (e.g., for specific UEs 105), based on the generated anomaly scores.

Data network 115 may include one or more interconnected networks, such as local area networks (LANs), wide area networks (WANs), metropolitan area networks (MANs), and/or the Internet. Data network 115 may connect with UPFs 140 of mobile network 110.

DNS server 120 includes one or more network devices that maintain a database that relates public Internet Protocol (IP) addresses to domain names of hosts. The DNS server 120, using the database, translates particular domain names of hosts to their IP addresses, and returns the host's IP address to the requesting entity (e.g., slice traffic manager 180).

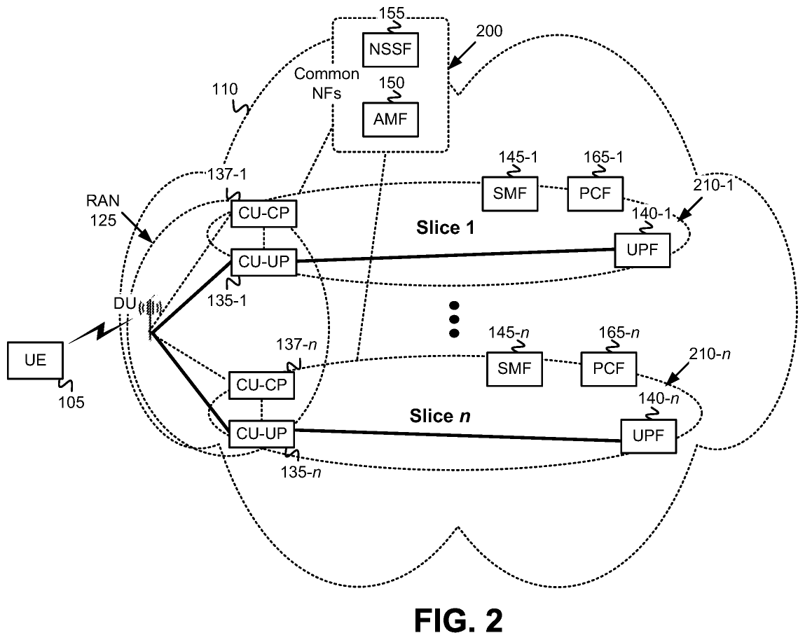

The configuration of network components of the example network environment 100 of FIG. 1 is for illustrative purposes. Other configurations may be implemented. Therefore, network environment 100 may include additional, fewer, and/or different components that may be configured in a different arrangement than that depicted in FIG. 1. For example, core network 130 may include other NFs not shown in FIG. 1. As a further example, though mobile network 110 is depicted in FIG. 1 as a 5G network having 5G network components/functions, mobile network 110 may alternatively include a Fourth Generation (4G) or 4.5G network with corresponding network components/functions, or a hybrid Next Generation/4G network that includes certain components of both a Next Generation network (e.g., a 5G network) and a 4G network. Additionally, though only a single one of each of the NFs UPF 140, SMF 145, AMF 150, NSSF 155, UDM 160, PCF 165, and NRF 170 is shown in FIG. 1, mobile network 110 may include multiple instances of each of these NFs. For example, each network slice (as described with respect to FIG. 2 below) may include its own SMF 145, PCF 165, and UPF 140.

FIG. 2 depicts an example of the division of the mobile network 110 into multiple (n) network slices. Each network slice of network slices 210-1 through 210-n may include a logical end-to-end network, which may run on a shared physical infrastructure, that is created to serve a particular purpose and/or service data traffic with a particular set of performance parameters or characteristics. For example, each network slice of network slices 210-1 through 210-n may service a particular service type and/or may satisfy or meet particular performance characteristics or parameters for sessions served by the network slice. In some implementations, each network slice may have a different Slice/Service Type (SST), such as, for example, an enhanced Mobile Broadband (eMBB) SST, an Ultra Reliable Low Latency Communications (URLLC) SST, or a Massive Internet of Things (mIoT) SST. Each network slice may, however, have a different SST not described herein.

As shown in FIG. 2, a group of common NFs 200 of mobile network 110 may service the various different network slices 210-1 through 210-n (where n is greater than or equal to two) and, therefore, may not be considered to be included within the network slices 210-1 through 210-n. In the example shown, the common NFs 200 of mobile network 110 may include an AMF 150 and a NSSF 155.

Each network slice may include its own dedicated set of NFs, where each NF operates to service UE sessions handled by that particular network slice. For example, as shown in FIG. 2, network slice 210-1 includes SMF 145-1, PCF 165-1, UPF 140-1, CU-UP 135-1, and CU-CP 137-1 that may operate to exclusively service traffic of UE sessions within network slice 210-1. As a further example, network slice 210-n includes SMF 145-n, PCF 165-n, UPF 140-n, CU-UP 135-n, and CU-CP 137-n that may operate to exclusively service traffic of UE sessions within network slice 210-n.

Each network slice 210 may be served by one or more NSIs. An NSI, as referred to herein, includes a set of NF instances and the resources (e.g., compute, storage, and networking resources) required to form a deployed NSI for serving a particular network slice. Thus, each network slice 210 may include one or more NSIs, with each NSI serving the overall purpose and/or performance requirements of the network slice 210 within the constraints of the network slice 210, and each NSI may be assigned its own NSI identifier (ID). Each network slice 210 may be assigned an S-NSSAI value that uniquely identifies the network slice. The S-NSSAI value may include a Slice/Service Type (SST) value and a Slice Differentiator (SD) value (e.g., S-NSSAI=SST+SD). The SST may define the expected behavior of the network slice in terms of specific features and services. The SD value may be directly related to the SST value and may be used as an additional differentiator (e.g., if multiple network slices carry the same SST value). The S-NSSAI and NSI IDs, of the different NSIs within the network slice, may be used within mobile network 110 for network slice and NSI selection for servicing UE sessions.

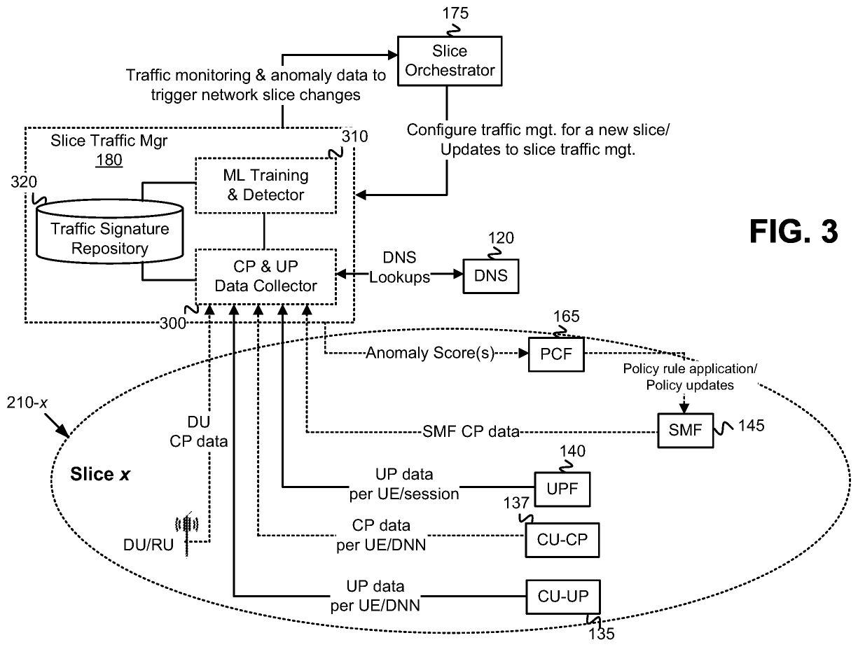

FIG. 3 illustrates an example of the interoperation of slice traffic manager 180, slice orchestrator 175, and various NFs of mobile network 110 (e.g., PCF 165, SMF 145, UPF 140, CU-CP 137, CU-UP 135) that are associated with a particular network slice 210-x, for performing traffic signature-based network slice policy actions, as described further herein.

In the example shown, slice traffic manager 180 may include a Control Plane (CP) and User Plane (UP) data collector 300, a ML training and detector 310, and a traffic signature repository 320. CP and UP data collector 300 monitors traffic attributes of CP/UP traffic for each network slice (e.g., network slice 210-x in FIG. 3). For example, as shown in FIG. 3, data collector 300 may monitor the traffic attributes of CP/UP traffic that includes CP data from SMF 145, UP data per UE and/or per session from UPF 140, CP data per UE and/or per DNN from CU-CP 137, UP data per UE and/or per DNN from CU-UP 135, and/or CP data from a DU or RU.

CP and UP data collector 300 receives configuration data that identifies the traffic attributes to collect for each network slice, and identifies monitoring thresholds to apply for each network slice. During traffic signature generation, CP and UP data collector 300 supplies at least a portion of the monitored traffic attributes of the CP/UP traffic for each network slice to ML training and detector 310 as training data. When using the known traffic signatures to trigger application of PCF policy rules, or to trigger the updating of PCF policies, CP and UP data collector 300 supplies collected traffic attributes, which satisfy certain monitoring thresholds, to ML training and detector 310.

ML training and detector 310 applies ML to training data to learn traffic patterns for each network slice, including per flow, per session, and/or per UE within each network slice, and stores the learned traffic patterns, as traffic signatures, in traffic signature repository 320. Traffic signature repository 320 may include a data structure that stores the traffic signature data for each network slice received from ML training and detector 310. ML training and detector 310 further receives collected traffic attributes from CP and UP data collector 300, which satisfy certain configured monitoring thresholds, and determines, for the monitored traffic attributes, distance metrics from known traffic signatures for the network slice obtained from traffic signature repository 320. ML training and detector 310 generates an anomaly score(s) based on the determined distance metrics for the network slice, and triggers application of PCF policy rules, by PCF 165 and SMF 145, based on the generated anomaly score(s) and/or triggers updating of PCF policies, at PCF 165, based on the generated anomaly score(s). FIG. 3 depicts slice traffic manager 180 sending a generated anomaly score(s) to PCF 165 for triggering the application of policy rules to traffic by SMF 145, or for triggering policy updates by PCF 165.

As further shown in FIG. 3, slice orchestrator 175 initiates the configuration of traffic management, implemented by slice traffic manager 180 for each new network slice, and additionally initiates updates to traffic management, for a selected network slice(s), that is to be implemented by slice traffic manager 180. Slice traffic manager 180 further supplies traffic monitoring and anomaly data to slice orchestrator 175 to potentially trigger network slice changes, including, for example, adding a new network slice, reconfiguring/modifying an existing network slice(s), and/or reconfiguring/modifying traffic management for an existing network slice(s).

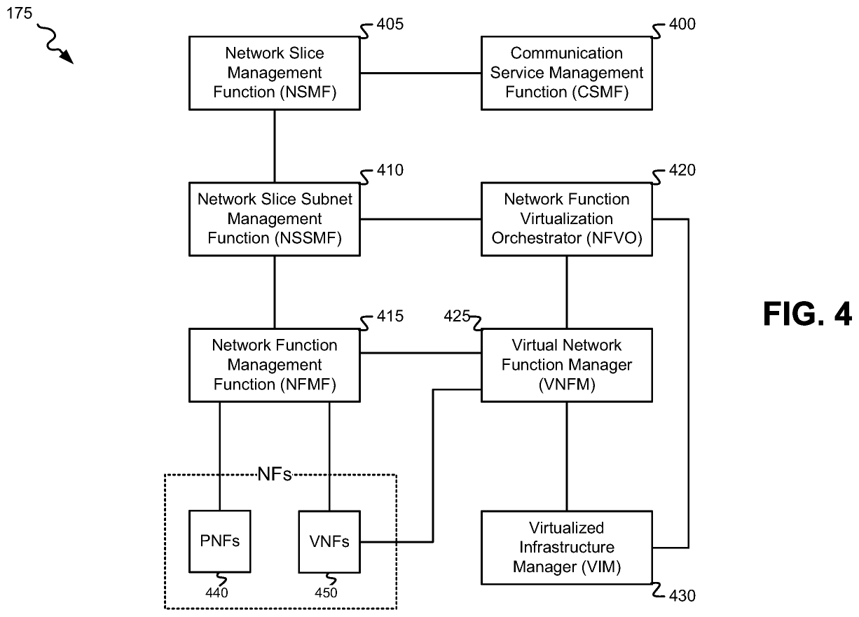

FIG. 4 illustrates exemplary components of the slice orchestrator 175 of FIG. 1 related to network slice management and orchestration. Slice orchestrator 175 may include, among other functions, a Communication Service Management Function (CSMF) 400, a Network Slice Management Function (NSMF) 405, a Network Slice Subnet Management Function (NSSMF) 410, a Network Function Management Function (NFMF) 415, a Network Function Virtualization Orchestrator (NFVO) 420, a Virtual Network Function Manager (VNFM) 425, a Virtualized Infrastructure Manager (VIM) 430, and Network Functions (NFs) 440 and 450. The functions of slice orchestrator 175 may be executed by a single network device or may be executed by multiple network devices interconnected via a network and/or one or more links.

CSMF 400 includes NFs that provision and manage communication service instances within mobile network 110. CSMF 400 requests necessary resources to implement the communication service instances and carries out service assurance and Service Level Agreement (SLA) enforcement for each service instance in active operation.

NSMF 405 includes NFs that perform NSI monitoring, reporting, and life cycle management. NSMF 405, for example, performs slice level/NSI health monitoring, SLA assurance, and slice/NSI life cycle management. NSSMF 410 performs network slice subnet instance (NSSI) monitoring, reporting, and life cycle management. NSSMF 410, for example, performs alarm correlation and statistics aggregation at the slice subnet level, and NSSI life cycle management and provisioning according to the slice profile.

NFMF 415 includes NFs that perform NF monitoring, reporting, and configuring. NFMF 415, for example, performs NF parameter configuration and provisioning. NFVO 420 includes NFs that perform resource and network service orchestration within mobile network 110. For resource orchestration, NFVO 420 oversees the allocation of resources and monitors the allocated resources. The resources may include compute resources (e.g., VNFs 450), storage resources, and network resources. The network resources may include ports, subnets, forwarding rules, etc. needed for inter-VNF communications. For network service orchestration, NFVO 420 manages VNF deployment, creates and terminates links/networks between VNFs, increases/decreases network service capacity, updates VNF forwarding information, and instantiates VNFs in coordination with VNFM 425.

VNFM 425 includes NFs that perform life cycle management of VNFs, including VNF instantiation, scaling of VNFs, updating/upgrading of VNFs, and termination of VNFs. NFVO 420 coordinates with VNFM 425 to instantiate VNFs and manage the deployment of network services that are made up of VNFs. VNFM 425 further performs key performance indicator (KPI) monitoring. VIM 430 includes NFs that control and manage the NFV infrastructure (NFVI) compute resources, storage resources, and network resources in coordination with NFVO 420 and VNFM 425. NFs 440 and 450 may include Physical NFs (PNFs) 440 and VNFs 450. PNFs 440 include physical network nodes which have not undergone virtualization. Both PNFs 440 and VNFs 450 can be used to implement an overall network service.

The configuration of the components of slice orchestrator 175 of FIG. 4 is for illustrative purposes. Other configurations may be implemented. Therefore, slice orchestrator 175 may include additional, fewer and/or different components, arranged in a different configuration, than depicted in FIG. 4.

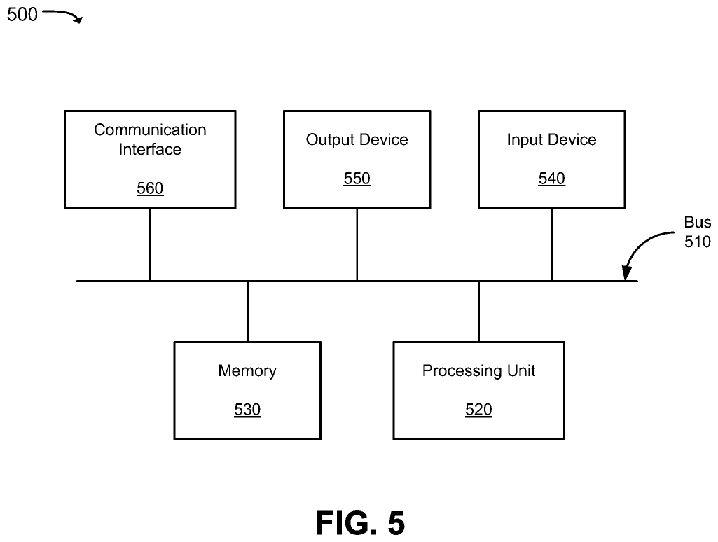

FIG. 5 is a diagram that depicts exemplary components of a network device 500 (referred to herein as a “network device” or a “device”). UEs 105, the DUs and RUs of RAN 125, slice orchestrator 175, and slice traffic manager 180 may include components that are the same as, or similar to, those of device 500 shown in FIG. 5. Furthermore, each of the network functions UPF 140, SMF 145, AMF 150, NSSF 155, UDM 160, PCF 165, and NRF 170 may be implemented by a device that includes components that are the same as, or similar to, those of network device 500. Some of the NFs UPF 140, SMF 145, AMF 150, NSSF 155, UDM 160, PCF 165, and NRF 170 may be implemented by a same device 500 within mobile network 110, while others of the functions may be implemented by one or more separate devices 500 within mobile network 110.

Device 500 may include a bus 510, a processing unit 520, a memory 530, an input device 540, an output device 550, and a communication interface 560. Bus 510 may include a path that permits communication among the components of device 500. Processing unit 520 may include one or more processors or microprocessors which may interpret and execute instructions, or processing logic. Memory 530 may include one or more memory devices for storing data and instructions. Memory 530 may include a random access memory (RAM) or another type of dynamic storage device that may store information and instructions for execution by processing unit 520, a Read Only Memory (ROM) device or another type of static storage device that may store static information and instructions for use by processing unit 520, and/or a magnetic, optical, or flash memory recording and storage medium. The memory devices of memory 530 may each be referred to herein as a “tangible non-transitory computer-readable medium,” “non-transitory computer-readable medium,” or “non-transitory storage medium.” In some implementations, the processes/methods set forth herein can be implemented as instructions that are stored in memory 530 for execution by processing unit 520.

Input device 540 may include one or more mechanisms that permit an operator to input information into device 500, such as, for example, a keypad or a keyboard, a display with a touch sensitive panel, voice recognition and/or biometric mechanisms, etc. Output device 550 may include one or more mechanisms that output information to the operator, including a display, a speaker, etc. Input device 540 and output device 550 may, in some implementations, be implemented as a user interface (UI) that displays UI information and which receives user input via the UI. Communication interface 560 may include a transceiver(s) that enables device 500 to communicate with other devices and/or systems. For example, communication interface 560 may include one or more wired and/or wireless transceivers for communicating via mobile network 110 and/or data network 115. In the case of RUs of RAN 125, communication interface 560 may further include one or more antenna arrays for producing radio frequency (RF) cells or cell sectors.

The configuration of components of network device 500 illustrated in FIG. 5 is for illustrative purposes. Other configurations may be implemented. Therefore, network device 500 may include additional, fewer and/or different components, that may be arranged in a different configuration, than depicted in FIG. 5.

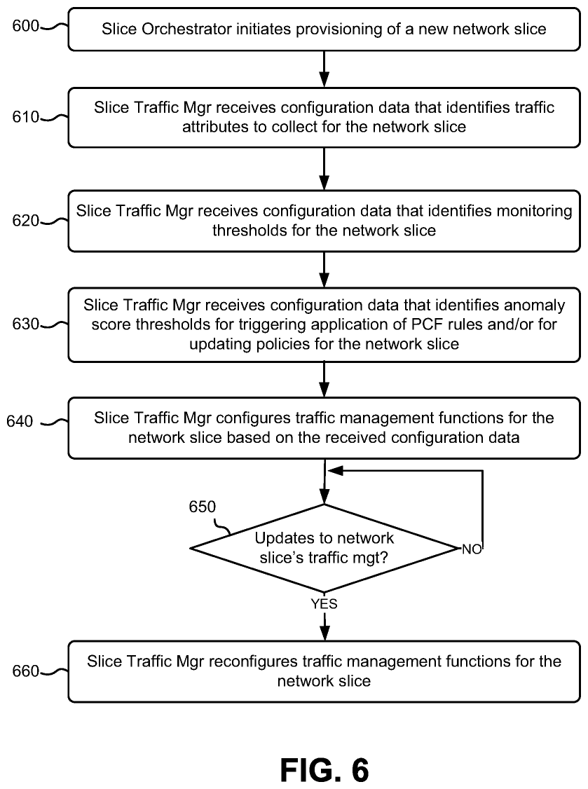

FIG. 6 is a flow diagram of an example process for configuring traffic management functions for a network slice. The exemplary process of FIG. 6 may be implemented by slice traffic manager 180 in conjunction with slice orchestrator 175. The example process of FIG. 6 may be executed for each network slice in mobile network 110 and, therefore, enables traffic management configuration to be customizable on a per network slice basis.

The exemplary process includes slice orchestrator 175 initiating the provisioning of a new network slice (block 600). CSMF 400, NSMF 405, NSSMF 410, NFMF 415, NFVO 420, VNFM 425, and VIM 430 of slice orchestrator 175 engage in cooperative actions to provision a new network slice in mobile network 110, including virtual resource allocation and instantiation, and configuring VNFs for the network slice.

Slice traffic manager 180 receives configuration data that identifies traffic attributes to collect for the network slice (block 610), receives configuration data that identifies monitoring thresholds for the network slice (block 620), and receives configuration data that identifies anomaly score thresholds for triggering application of PCF rules and/or for updating policies for the network slice (block 630). Slice orchestrator 175 may, in some circumstances, generate traffic management configuration data for a newly provisioned network slice and push the configuration data to slice traffic manager 180 to initiate the configuration of the traffic management functions for the network slice. In other circumstances, an operator may manually select and generate traffic management configuration parameters for inclusion in the configuration data, and cause the configuration data to be supplied to slice traffic manager 180.

The traffic management configuration data received by slice traffic manager 180 may include various configuration parameters that slice traffic manager 180 may use to configure the execution of traffic management functions for a particular network slice to enable slice traffic manager 180 to begin monitoring the traffic of the network slice. The traffic attributes identified in the configuration data (e.g., block 610) may include traffic volume characteristics (e.g., download (DL) volumes, upload (UL) volumes, ratio of DL to UL traffic), types of traffic (e.g., protocols on DL vs. UL, DNS lookup to identify app servers associated with particular traffic), and/or temporal aspects of traffic (e.g., inter-packet arrival gaps, session duration, burstiness of packets, packet size). The traffic attributes identified in the configuration data may further include an identification of the granularity of the traffic data to be monitored, such as, for example, per flow, per session, or per UE. The traffic attributes identified in the configuration data may further include an identification of particular CP or UP data to be monitored, such as, for example, UP data from a UPF(s) 140 of the network slice on a per UE or per session basis, CP data from a CU-CP(s) 137 of the network slice on a per UE or per DNN basis, UP data from a CU-UP(s) of the network slice on a per UE or per DNN basis, CP data from a SMF(s) 145 of the network slice, or CP data from a DU(s) of the network slice.

The monitoring thresholds for the network slice (e.g., block 620) may identify threshold levels of one or more of the traffic attributes of block 610 that indicate a level of traffic attribute that justifies collecting and storing the traffic attribute for traffic pattern learning or traffic signature identification.

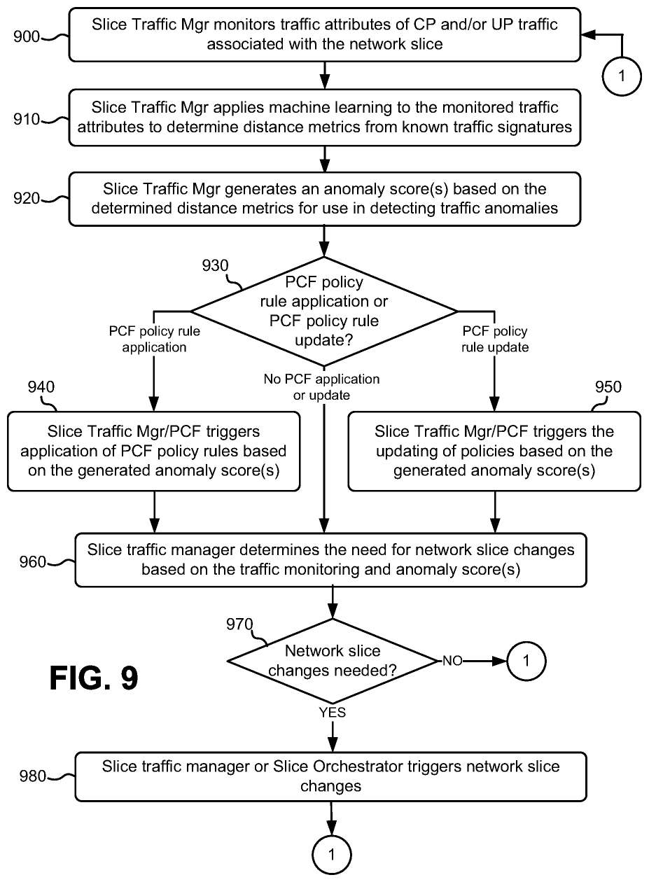

The anomaly score thresholds may specify a threshold level(s) at which policy actions (e.g., application of policy rules, updating of policies) may be triggered based on an anomaly score(s) that is generated by slice traffic manager 180 based on network slice traffic signatures (e.g., blocks 910 and 920 of FIG. 9 below).

Slice traffic manager 180 configures traffic management functions for the network slice based on the received configuration data (block 640). CP and UP data collector 300 of slice traffic manager 180 may be configured, based on the configuration parameters specified in the received configuration data, to monitor and collect particular CP and/or UP data in the network slice, and to apply specific configured monitoring thresholds to the monitored and collected CP and/or UP data in the network slice. Slice traffic manager 180 may further be configured, based on the configuration parameters specified in the received configuration data, to apply specific anomaly score thresholds for triggering application of PCF policy rules and/or for triggering PCF policy updates.

Slice traffic manager 180 determines whether there are updates to the network slice's traffic management functions (block 650). Slice orchestrator 175 may, in some circumstances, generate updates to one or more configuration parameters and push the updated configuration data to slice traffic manager 180 for re-configuring of the traffic management functions. In other circumstances, an operator, or other entity, may select and generate updates to one or more configuration parameters and cause updated configuration data to be supplied to slice traffic manager 180 for re-configuring the traffic management functions. Determining whether there are updates may include repeating blocks 610-630 to receive updated/modified configuration data for the network slice.

If there are updates to the network slice's traffic management functions (YES—block 650), slice traffic manager 180 reconfigures the traffic management functions for the network slice (block 660). Slice traffic manager 180 may, based on updated configuration data, modify which CP and/or UP data to be monitored and collected in the network slice, modify the previously configured monitoring thresholds to be applied to the monitored CP and/or UP data, and/or modify the anomaly score thresholds for triggering application of PCF policy rules and/or triggering PCF policy updates. If there are no updates to the network slice's traffic management functions (NO—block 650), then block 650 may repeat until updates are received.

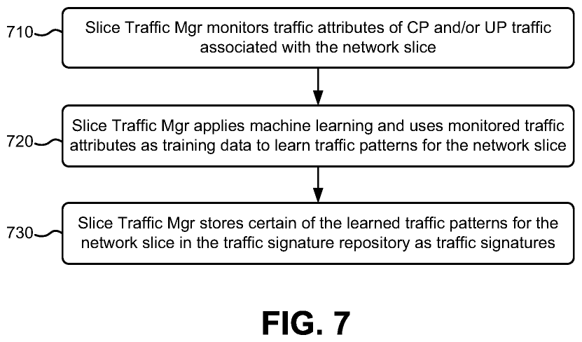

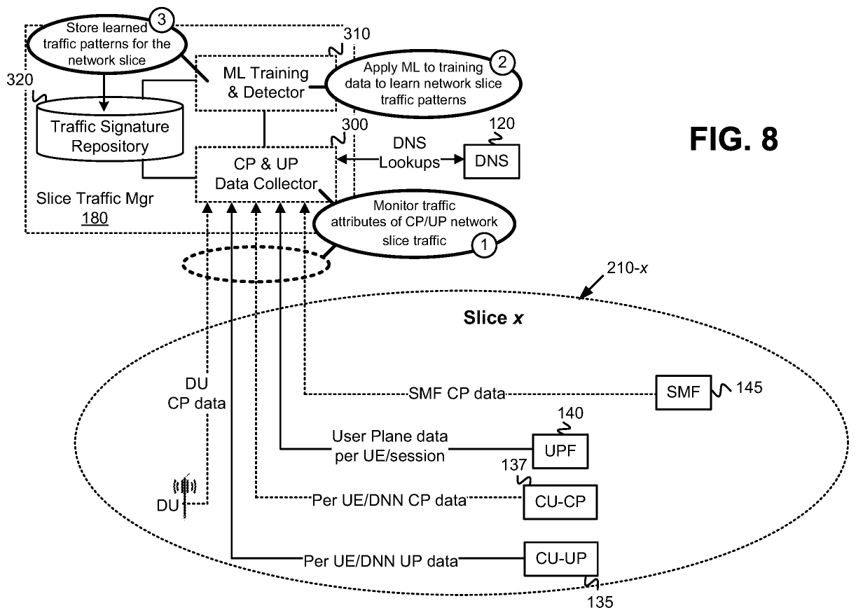

FIG. 7 is a flow diagram of an example process for monitoring traffic associated with a network slice, learning traffic patterns of traffic in the network slice, and generating and storing corresponding traffic signatures of traffic associated with the network slice. The exemplary process of FIG. 7 may be implemented by slice traffic manager 180. In some circumstances, the example process of FIG. 7 may be implemented during a testing phase involving test traffic sent from one or more test devices (e.g., UEs 105, or other type of network device(s)) via the network slice. In other circumstances, the example process of FIG. 7 may be implemented continuously, or periodically, during regular operation of the network slice to determine updated traffic signatures as traffic may evolve over the network slice over time. The example process of FIG. 7 is described with additional reference to FIG. 8.

The example process includes slice traffic manager 180 monitoring traffic attributes of CP and/or UP traffic associated with a network slice (block 710). CP and UP data collector 300 of slice traffic manager 180 monitors particular traffic attributes of CP and/or UP data in the network slice, as previously configured in block 640 of FIG. 6 based on the configuration data received for the network slice in block 610 of FIG. 6. Data collector 300 may have been previously configured to monitor particular traffic attributes of CP data of SMF 145, UP data of UPF 140, CP data of CU-CP 137, UP data of CU-UP 135, and/or CP data of DU within the network slice. The traffic attributes to be monitored may include, for example, traffic volume characteristics (e.g., DL volumes, UL volumes, ratio of DL to UL traffic), types of traffic (e.g., protocols on DL vs. UL, DNS lookup to identify app servers associated with particular traffic), and/or temporal aspects of traffic (e.g., inter-packet arrival gaps, session duration, burstiness of packets, packet size). Data collector 300 may further have been previously configured to monitor the network slice's traffic based on a particular granularity, such as, for example, per flow, per session, and/or per UE. Data collector 300 may additionally have been previously configured to monitor particular CP and/or UP data within the network slice, such as, for example, UP data from a UPF(s) 140 of the network slice on a per UE or per session basis, CP data from a CU-CP(s) 137 of the network slice on a per UE or per DNN basis, UP data from a CU-UP(s) of the network slice on a per UE or per DNN basis, CP data from a SMF(s) 145 of the network slice, and/or CP data from a DU(s) of the network slice. FIG. 8 illustrates CP and UP data collector 300 monitoring (identified as a “1” within a circle) traffic attributes of CP and/or UP network slice traffic of network slice 210-x.

Slice traffic manager 180 applies ML and uses monitored traffic attributes as training data to learn traffic patterns for the network slice (block 720), and stores certain of the learned traffic patterns for the network slice in the traffic signature repository as “traffic signatures” (block 730). Existing ML techniques may be executed by ML training and detector 310 of slice traffic manager 180 to learn, based on the monitored traffic attributes, traffic patterns for the network slice and to determine certain of the learned traffic patterns as being traffic signatures for the network slice. ML training and detector 310 may, upon determining the traffic signatures for the network slice, store the determined traffic signatures in traffic signature repository 320 as known, current traffic signatures for the network slice. Traffic signature repository 320 may, therefore, store traffic signatures received from ML training and detector 310 on a per network slice basis. The ML may, for example, learn application, game and/or UE specific traffic patterns for the network slice. As one example, a cloud gaming application may have the following traffic patterns: 1) on the downlink, a high volume of Real-time Transport Protocol (RTP) or Real-time Streaming Protocol (RTSP) packets with near constant inter-packet arrival times; 2) on the downlink, a small volume of initial STUN, TURN, or ICE traffic at session set-up; 3) on the uplink, UDP/DTLS, STUN, TURN, or ICE traffic; and 4) high downlink traffic, as compared to uplink traffic.

For some network slices, the traffic signatures may be dynamic in nature, so the example process of FIG. 7 may continuously, or periodically, be repeated to learn new traffic patterns for the slice, and to update the traffic signatures stored in repository 320. FIG. 8 illustrates ML training and detector 310 applying ML (identified as a “2” within a circle) to training data to learn traffic patterns of network slice 210-x, and then storing the learned traffic patterns (identified as a “3” within a circle), as traffic signatures, within traffic signature repository 320.

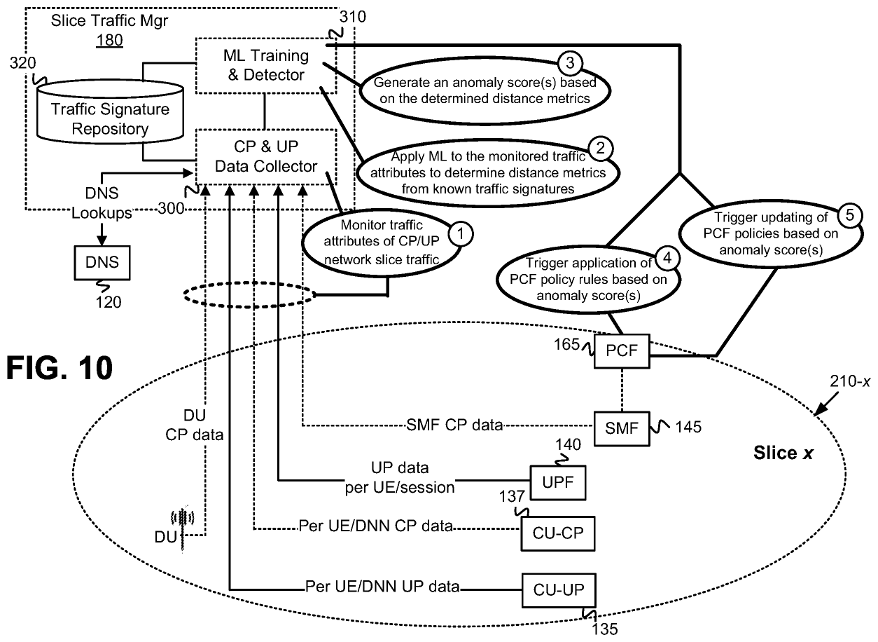

FIG. 9 is a flow diagram of an example process for applying ML to monitored traffic of a network slice to detect traffic anomalies, the detection of which may be used to trigger PCF policy rule application to traffic in the network slice, or to trigger the updating of PCF policies for traffic in the network slice. The example process of FIG. 9 may be implemented by slice traffic manager 180, and is described with additional reference to FIG. 10.

The example process includes slice traffic manager 180 monitoring traffic attributes of CP and/or UP traffic associated with a particular network slice (block 900). CP and UP data collector 300 of slice traffic manager 180 monitors particular traffic attributes of CP and/or UP data in the network slice, as previously configured in block 640 of FIG. 6 based on the configuration data received for the network slice in block 610 of FIG. 6. As previously described with respect to block 710 of FIG. 7, data collector 300 may be configured to monitor particular traffic attributes of CP data of SMF 145, UP data of UPF 140, CP data of CU-CP 137, UP data of CU-UP 135, and/or CP data of DU within the network slice. The traffic attributes to be monitored may include, for example, traffic volume characteristics, types of traffic, and/or temporal aspects of traffic which may be monitored on a per flow, per session, and/or per UE basis. FIG. 10 illustrates CP and UP data collector 300 monitoring (identified as a “1” within a circle) traffic attributes of CP and/or UP network slice traffic of network slice 210-x.

Slice traffic manager 180 applies ML to the monitored traffic attributes to determine distance metrics from known traffic signatures (block 910). Anomalies may be detected in the monitored network slice traffic using ML techniques, such as, for example, using a Random Cut Forest (RCF) ML algorithm, that determines a “distance” of monitored traffic attributes from known reference points. The known reference points may include, for example, the traffic signatures for the network slice previously stored in traffic signature repository 320 (i.e., stored in repository 320 in block 730 of FIG. 7). The distance of monitored traffic attributes from the previously stored traffic signatures may be calculated as “distance metric” values. RCF detects anomalous data points within a data set that diverge from patterns of data, and generates a distance metric score that measures a “distance” of the divergent data from the previously stored traffic signatures. The distance metric score may, as described below, further be used to generate an “anomaly score” that detects possible anomalies in the monitored traffic attributes of the network slice and which may also, based on a magnitude of the anomaly score, indicate a level (e.g., large, medium or small) of the anomaly. FIG. 10 illustrates ML training and detector 310 applying ML (identified with a “2” within a circle) to the monitored traffic attributes to determine distance metrics from known traffic signatures stored in repository 320.

Slice traffic manager 180 generates an anomaly score(s) based on the determined distance metrics for use in detecting traffic anomalies (block 920). The distance metrics determined by the ML, in block 910, may be used to generate an anomaly score(s) for the network slice that serves to indicate a level of anomaly occurring in the monitored traffic attributes relative to the traffic signatures of the network slice. In one implementation, the anomaly score(s) may be generated as a function of the distance metrics, determined in block 910, from the stored traffic signatures for the network slice. Slice traffic manager 180 may send the generated anomaly score(s) to a PCF 165. FIG. 10 illustrates ML training & detector 310 generating (identified with a “3” within a circle) an anomaly score(s) based on the determined distance metrics.

Slice traffic manager 180, or a PCF 165 that has received the generated anomaly score(s) from slice traffic manager 180, determines whether to trigger PCF policy rule application, or PCF policy rule updates (block 930). Slice traffic manager 180 or PCF 165 compares the anomaly score(s) generated in block 920 with anomaly score thresholds previously received in block 630 of FIG. 6 as part of the configuration data. An anomaly score that exceeds a first anomaly score threshold may trigger PCF policy rule application, and an anomaly score that exceeds a second anomaly score threshold may trigger PCF policy rule updates. Triggering policy actions (e.g., policy rule application, policy rule updates) may, for example, be UE specific.

If PCF policy rule application is triggered (“PCF policy rule application”—block 930), then slice traffic manager 180 or PCF 165 triggers application of PCF policy rules based on the generated anomaly score(s) (block 940). For example, if the anomaly score is greater than a first anomaly score threshold, then slice traffic manager 180 may cause PCF 165 to apply one or more policy rules to traffic in the network slice by SMF 145. FIG. 10 illustrates PCF 165 triggering (identified with a “4” within a circle) application of policy rules based on the generated anomaly score(s).

If PCF policy rule update is triggered (“PCF policy rule update”—block 930), then slice traffic manager 180 or PCF 165 triggers the updating of policy rules based on the generated anomaly score(s) (block 950). As an example, if the anomaly score is greater than a second anomaly score threshold, then slice traffic manager 180 may cause PCF 165 to update policy rules to be applied to traffic in the network slice by SMF 145. In response to triggering by slice traffic manager 180, PCF 165 may revise or update one or more policy rules that are to be applied to traffic in the network slice, and may push the revised or updated policy rule(s) to SMF 145 for application to the traffic in the network slice. The policy rule updates may, for example, be updates to PCF policy rules for the entire network slice or may be UE specific updates to PCF policy rules (e.g., PCF policy rule changes that are network slice or UE specific). For example, if there is a change in a particular Quality of Service (QOS) parameter (e.g., the Access Point Name (APN)-Aggregated Maximum Bit Rate (AMBR) parameter), an updated policy rule may reduce the maximum bit rate for the DNN that a particular UE is using, reducing the impact of the UE on the network slice. As another example, if there is a QoS Class Identifier (QCI) or QoS Flow Identifier (QFI) change, an updated policy rule may reduce the priority of traffic from a particular UE by changing its QCI value (e.g., QCI=133 to QCI=9). FIG. 10 illustrates PCF 165 triggering (identified with a “5” within a circle) the updating of PCF policies based on the generated anomaly score(s).

If no PCF application or rule updates are triggered (“No PCF application or update”—block 930), or subsequent to execution of block 940 or 950, slice traffic manager 180 determines the need for network slice changes based on the traffic monitoring and the anomaly score(s) (block 960). Alternatively, slice traffic manager 180 may send traffic monitoring and anomaly data to slice orchestrator 175, and slice orchestrator 175 may determine a need for network slice changes. The traffic monitoring performed in block 910, and the anomaly score(s) generated in block 920, may be used by slice traffic manager 180 and/or slice orchestrator 175 as a basis for determining whether changes in the network slice may be needed to handle the traffic currently traversing the network slice and maintain adequate traffic performance characteristics for the network slice. If network slice changes are not needed (NO—block 970), then the process returns to block 900 with continued monitoring of CP and UP traffic attributes. If network slice changes are determined to be needed (YES—block 970), the slice traffic manager 180 or slice orchestrator 175 triggers or initiates network slice changes (block 980), and the process subsequently may return to block 900.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with respect to FIGS. 6, 7, and 9, and sequences of operations, messages, and/or data flows with respect to FIGS. 8 and 10, the order of the blocks and/or the operations, messages, and/or data flows may be varied in other implementations. Moreover, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

Embodiments have been described without reference to the specific software code because the software code can be designed to implement the embodiments based on the description herein and commercially available software design environments and/or languages. For example, various types of programming languages including, for example, a compiled language, an interpreted language, a declarative language, or a procedural language may be implemented.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processing unit 320) of a device. A non-transitory storage medium includes one or more of the storage mediums described in relation to memory 330. The non-transitory computer-readable storage medium may be implemented in a centralized, distributed, or logical division that may include a single physical memory device or multiple physical memory devices spread across one or multiple network devices.

To the extent the aforementioned embodiments collect, store or employ personal information of individuals, such information shall be collected, stored, and used in accordance with all applicable laws concerning protection of personal information. Additionally, the collection, storage and use of such information can be subject to consent of the individual to such activity, for example, through well known “opt-in” or “opt-out” processes as can be appropriate for the situation and type of information. Collection, storage and use of personal information can be in an appropriately secure manner reflective of the type of information, for example, through various encryption and anonymization techniques for particularly sensitive information.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

All structural and functional equivalents to the elements of the various aspects set forth in this disclosure that are known or later come to be known to those of ordinary skill in the art are expressly incorporated herein by reference and are intended to be encompassed by the claims.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
monitoring first traffic associated with a network slice in a mobile network;
applying machine learning to the monitored first traffic to determine at least one metric for detecting traffic anomalies in the network slice; and
triggering, based on the determined at least one metric, at least one of:
applying policy rules to second traffic in the network slice, or
updating the policy rules for the network slice.

2. The method of claim 1, further comprising:
monitoring third traffic associated with the network slice;
applying the machine learning to learn traffic patterns of the network slice; and
determining traffic signatures for the network slice based on the learned traffic patterns,
wherein the at least one metric comprises at least one distance metric, and wherein applying the machine learning further determines the at least one distance metric relative to the determine traffic signatures.

3. The method of claim 2, wherein the third traffic comprises training data sent over the network slice.

4. The method of claim 2, wherein, when learning the traffic patterns, the machine learning comprises a Random Cut Forest (RCF) technique.

5. The method of claim 1, further comprising:
generating at least one anomaly score based on the determined at least one metric,
wherein the triggering is further based on the at least one anomaly score.

6. The method of claim 5, further comprising:
determining, based on the monitored first traffic and the at least one anomaly score, a need for changes to the network slice; and
triggering changes to the network slice based on the determined need for changes.

7. The method of claim 1, further comprising:
receiving configuration data associated with performing traffic management functions for the network slice,
wherein monitoring the first traffic is based on the received configuration data.

8. The method of claim 7, wherein the configuration data comprises at least one of:
data that identifies traffic attributes to collect for the network slice;
data that identifies monitoring thresholds for the network slice; or
data that identifies thresholds associated with the determined at least one metric.

9. The method of claim 2, wherein determining the traffic signatures for the network slice comprises:
storing certain of the learned traffic patterns as the traffic signatures in a traffic signature repository.

10. The method of claim 1, wherein monitoring the first traffic comprises:
monitoring traffic attributes of control plane (CP) and User Plane (UP) traffic associated with the network slice.

11. A network device, comprising:
at least one communication interface configured to communicate via a network; and
at least one processor configured to:
monitor first traffic associated with a network slice in a mobile network,
apply machine learning to the monitored first traffic to determine at least one metric for detecting traffic anomalies in the network slice, and
trigger, based on the determined at least one metric, at least one of:
apply policy rules to second traffic in the network slice, or
update the policy rules for the network slice.

12. The network device of claim 11, wherein the at least one processor is further configured to:
monitor third traffic associated with the network slice;
apply the machine learning to learn traffic patterns of the network slice; and
determine traffic signatures for the network slice based on the learned traffic patterns,
wherein the at least one metric comprises at least one distance metric, and wherein applying the machine learning further determines the at least one distance metric relative to the determine traffic signatures.

13. The network device of claim 12, wherein, when learning the traffic patterns, the machine learning comprises a Random Cut Forest (RCF) technique.

14. The network device of claim 11, wherein the at least one processor is further configured to:
generate at least one anomaly score based on the determined at least one metric,
wherein the triggering is further based on the at least one anomaly score.

15. The network device of claim 14, wherein the at least one processor is further configured to:
determine, based on the monitored first traffic and the at least one anomaly score, a need for changes to the network slice; and
trigger changes to the network slice based on the determined need for changes.

16. The network device of claim 11, wherein the at least one processor is further configured to:
receive configuration data associated with performing traffic management functions for the network slice,
wherein monitoring the first traffic is based on the received configuration data, and
wherein the configuration data comprises at least one of:
data that identifies traffic attributes to collect for the network slice,
data that identifies monitoring thresholds for the network slice, or
data that identifies thresholds associated with the determined at least one metric.

17. A non-transitory storage medium storing instructions executable by a network device, wherein the instructions comprise instructions to cause the network device to:
monitor first traffic associated with a network slice in a mobile network;
apply machine learning to the monitored first traffic to determine at least one metric for detecting traffic anomalies in the network slice; and
trigger, based on the determined at least one metric, at least one of:
applying policy rules to second traffic in the network slice, or
updating the policy rules for the network slice.

18. The non-transitory storage medium of claim 17, wherein the instructions further comprise instructions to cause the network device to:
monitor third traffic associated with the network slice;
apply the machine learning to learn traffic patterns of the network slice; and
determine traffic signatures for the network slice based on the learned traffic patterns,
wherein the at least one metric comprises at least one distance metric, and wherein applying the machine learning further determines the at least one distance metric relative to the determine traffic signatures.

19. The non-transitory storage medium of claim 17, wherein the instructions further comprise instructions to cause the network device to:
generate at least one anomaly score based on the determined at least one metric,
wherein the triggering is further based on the at least one anomaly score.

20. The non-transitory storage medium of claim 19, wherein the instructions further comprise instructions to cause the network device to:
determine, based on the monitored first traffic and the at least one anomaly score, a need for changes to the network slice; and
trigger changes to the network slice based on the determined need for changes.
